(19) United States
(12) Patent Application Publication
(10) Pub. No.: US 2013/0001267 A1
(43) Pub. Date: Jan. 3, 2013

(54) Vehicle utility rack

(76) Inventor: Paul Infantino, Reno, NV (US)

(21) Appl. No.: 13/135,309

(22) Filed: Jun. 28, 2011

(51) Int. Cl. B60R 9/00

(52) U.S. Cl. 224/539

(57) ABSTRACT

A vehicle rack, such as for a recreational utility vehicle, comprises two or more supports which support a raised storage area. The raised storage area comprises at least one decked portion for supporting cargo, such as above a cab of the vehicle. A lower area is defined below the raised storage area and within the supports. The lower area may be generally enclosed by rear and/or side panels. The rear and/or side panels may be moved between closed and open positions. The rear and/or side panels may also be moved to a seating or shelf position. The rack may be mounted to a tilting bed of a vehicle so as to move with the bed.

### FIELD OF THE INVENTION

The present invention relates to storage racks and carriers for vehicles.

### BACKGROUND OF THE INVENTION

Users of vehicles, such as cars, trucks and off-road or all-terrain vehicles commonly need to associate cargo with their vehicle. The vehicles may include various cargo areas. In the case of a car, one such cargo area is a trunk. In the case of a truck, one such cargo area may be an open truck bed.

In many instances, however, these cargo areas either do not provide sufficient cargo area or are not well-suited to the particular cargo that the user desires to stow. For example, a user may wish to associate a bicycle with their car. Commonly, however, a bicycle is too large to fit into the trunk of a car. Thus, various external bicycle carriers have been developed. These may include hitch-mounted and roof mounted carriers.

In the case of trucks and off-road vehicles, a user may wish to associate camping or hunting gear, tools or other items. Covers have been developed for containing cargo which is located in a truck bed. In addition, various small racks such as front racks and roof racks, have been developed for off-road and similar vehicles.

However, all of the existing racks have various drawbacks. For example, in some instances a user is required to mount multiple small racks at various points of their off-road vehicle in order to provide sufficient total cargo storage capacity. The large number of individual small racks increases the cost associated with providing adequate storage and requires a great deal of time to install and maintain. In other instances the racks may interfere with the operation of the vehicle, such as by impeding access to certain areas of the vehicle or the like.

### SUMMARY OF THE INVENTION

One aspect of the invention is a rack for a vehicle. The rack has particular utility to a recreational utility vehicle (RUV) or a utility task vehicle (UTV), but may be used with vehicles of various types.

In one embodiment, the rack has a raised storage area. The raised storage area may be supported in a raised position by one or more supports.

The raised storage area may comprise frame having a lower portion and a raised portion. The frame may define a front portion and a rear portion of the raised storage area. In one embodiment, the rear portion of the frame is generally open, while the front portion is generally closed, such as with decking.

In one embodiment, the raised storage area is supported by four supports. A lower area may be defined below the raised storage area and within the supports.

The lower area may be at least partially enclosed by one or more panels. In one embodiment, the rack has a rear and a pair of opposing sides. A rear panel is located between rear supports at the rear of the rack and side panels are located between side supports at the opposing sides of the rack.

In one embodiment, the panels may be moved from a generally vertical position in which they serve to at least partially enclose the lower area to an open position, such as a generally horizontal position, such as to provide access to the lower area of the rack.

The rear panel may also be moved to a raised shelf position. In yet another configuration, the rear panel may be rotated inwardly to a generally horizontal seating position.

In use, the supports of the rack may be connected or mounted to a vehicle, such as to a bed or frame thereof. Preferably, the raised storage area is elevated above the bed or frame. In a preferred configuration, a front portion of the raised storage area extends forwardly over a cab portion of the vehicle.

A user may store cargo on the raised storage area, such as the deck of the front portion thereof. A user may also locate cargo in the lower area of the rack and then secure that cargo by closing the rear and side panels.

The rack has numerous advantages. As one aspect of the invention, the rack may be used with a vehicle having a tilting bed, wherein the rack does not interfere with the tilting operation by moving with the bed when connected thereto.

Further objects, features, and advantages of the present invention over the prior art will become apparent from the detailed description of the drawings which follows, when considered with the attached figures.

### DESCRIPTION OF THE DRAWINGS

FIG. 1 is a perspective view of a rack in accordance with an embodiment of the present invention;

FIG. 2 is a side view of an embodiment of the rack of the present invention associated with a vehicle and having panels thereof in a raised position;

FIG. 3 is a rear view of an embodiment of the rack of the present invention associated with a vehicle and having panels thereof in a raised position;

FIG. 4 is a rear view of an embodiment of the rack of the present invention associated with a vehicle and having panels thereof in a lowered position;

FIG. 5 is a rear view of an embodiment of the rack of the present invention associated with a vehicle and having side panels thereof in a raised position and a rear panel thereof in a seating position;

FIG. 6 is a rear view of an embodiment of the rack of the present invention associated with a vehicle and having side panels thereof in a raised position and a rear panel thereof in a shelf position; and

FIG. 7 is a side view of an embodiment of the rack of the present invention associated with a vehicle and having panels thereof in a raised position, wherein a bed portion of the vehicle has been tilted.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a storage rack for a vehicle. As used herein, the term “vehicle” has broad applicability and may refer to any device configured to convey or transport items. In one embodiment, the vehicle is self-propelled, such as by one or more motors. However, the vehicle could be user-propelled. The term vehicle thus includes, but is not limited to, automobiles/cars, trucks and off-road or all-terrain vehicles. Such vehicles may or may not be street legal.

One type of vehicle to which the invention has particular utility is a recreational utility vehicle (RUV) or a utility task vehicle (UTV). One such vehicle is marketed by Yamaha Motor Corporation under the name RHINO™.

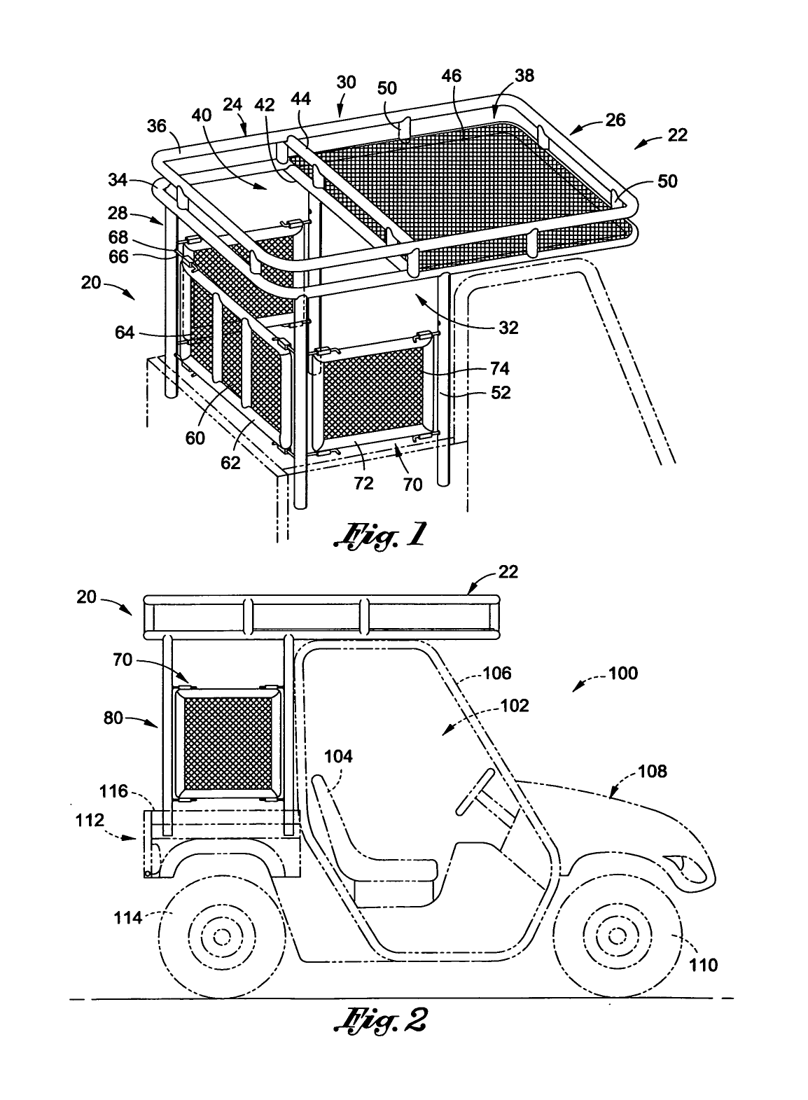

One embodiment of a vehicle rack 20 of the present invention will be described first with reference to FIG. 1. As illustrated therein, the rack 20 has a raised storage area 22. In one embodiment, the raised storage area 22 comprises a frame 24. In one embodiment, the raised storage area 22 is generally rectangular in shape, having a front 26, a rear 28, and a pair of opposing sides 30,32.

As illustrated, the frame 24 has a lower portion or base 34, and a raised portion or rail 36. In a preferred embodiment, the raised portion 36 is located generally vertically above the lower portion 34 of the frame 24. For example, the raised portion 36 may be supported above the lower portion 34 of the frame 24 about 3-6 inches by one or more struts or supports 50.

The frame 24 preferably defines a periphery of the raised storage area 22 as well as an internal or interior area. In one embodiment, the interior area of the raised storage area 22 is divided into one or more portions. In a preferred embodiment, the interior area of the raised storage area 22 is divided into a front portion 38 and a rear portion 40. For example, as illustrated, first and second cross-members 42,44 may span the interior area from opposing sides of the lower portion 34 and raised portion 36 of the frame 24.

The relative sizes of the front portion 38 and rear portion 40 may vary. In one embodiment, the front portion 38 is larger than the rear portion 40, such as by having the cross-members 42,44 be located rear of the midpoint of the frame 24 from front to back.

The front portion 38 of the raised storage area 22 may include a support surface or deck 46 upon which cargo may be stored or supported. In one embodiment, the support surface or deck 46 comprises expanded metal or mesh which is supported by the lower portion 34 of the frame 24. As illustrated, in a preferred embodiment, the rear portion 40 of the raised storage area 22 is open.

In one embodiment, as indicated, the storage area 22 is configured to be raised or elevated. Thus, in a preferred embodiment, the raised storage area 22 is supported by one or more supports 52.

As illustrated, in a preferred embodiment, the raised storage area 22 is supported by four (4) supports 52. In one embodiment, each support 52 has a bottom or distal end and a top or proximal end. The proximal ends of the supports 52 are connected to the frame 24 of the raised storage area 22, such as to the lower portion 34 thereof.

The locations of the supports 52 relative to the frame 24 of the raised storage area 22 may vary. However, in one preferred embodiment, the front portion of the raised storage area 22 is configured to project or extend outwardly, such as over a cab of a vehicle. In such a configuration, the supports 52 are preferably located towards the rear of the frame 24.

For example, as illustrated, a first pair of supports 52 is located at opposing sides of the frame 24 at or near its second or rear end 28. A second pair of supports 52 is located at opposing sides of the frame 24 towards the middle (i.e. between the front and rear ends 26,28) thereof, such as near the cross-members 42,44 of the frame 44 or near the midpoint of the frame 24 (and not at or near the front of the frame 24).

In one embodiment, each support 52 is straight and generally vertically extending. However, the supports 52 could have other shapes and other orientations.

As described below, the distal end of each support 52 is preferably configured to connect to a vehicle, either directly or indirectly. For example, the distal end of each support 52 may define a foot (not shown), such as a generally planar or angular mounting plate. That foot may be connected to a vehicle, such as by bolting it to a vehicle's bed.

As illustrated, the rack 20 has a lower portion or area 80. The lower portion 80 is generally located below the raised storage area 22 and within the bounds of the supports 52. In a preferred configuration, at least a portion of the lower portion or area 80 is located below the rear portion 40 of the raised storage area 22, thus permitting items which are located in the lower portion 80 to extend upwardly through the rear portion 40 of the raised storage area 22, as detailed below.

In a preferred embodiment, the rack 20 includes one or panels. As described below and illustrated in the figures, in one or more embodiments, the panels may have one or more functions including: (1) closing one or more areas of the rack 20; (2) serving as a supporting shelf; and/or (3) serving as a seat.

In one embodiment, the one or more panels are mounted to the supports 52, and preferably at least two of the supports 52. However, it is possible for one or more of the panels to be connected to or supported by other portions of the rack 20, such as the frame 24 of the raised storage area 22.

In one embodiment, the rack 20 includes a rear panel 60. In one embodiment, the rear panel 60 comprises a frame 62. The frame 62 may have various configurations. In one embodiment, the frame 62 is generally rectangular in shape and defines a periphery of the panel 60. As illustrated, the frame 62 may include one or more cross-members. An interior area of the panel 60 may be covered or filled, such as with expanded metal 64 or the like.

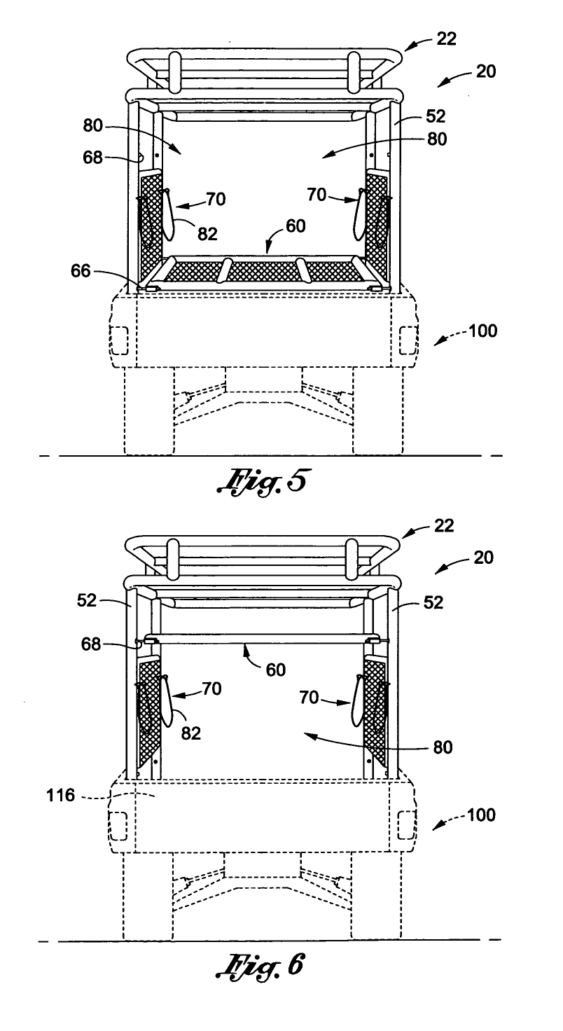

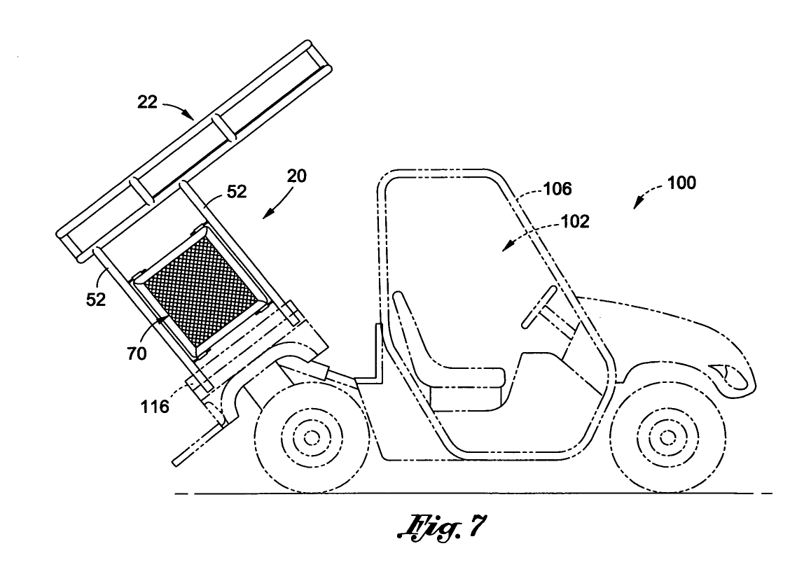

In one embodiment, the rear panel 60 is selectively mounted to the pair of rear supports 52. In one embodiment, the rear panel 60 can be attached to or removed from the rack 20. In a preferred embodiment, the rear panel 60 can be arranged into various orientations, such as one or more of: (1) a raised/closed position (as illustrated in FIGS. 1 and 3); (2) a lowered/tailgate position (as illustrated in FIG. 4); (3) a lowered/seat position (as illustrated in FIGS. 5); and (4) a shelf position (as illustrated in FIG. 6).

In one embodiment, the rear panel 60 may be mounted to the rack 20 by one or more pins 66. For example, as illustrated, the rear panel 60 may include four (4) pins 66 which are located at the corners thereof. The pins 66 may be associated with mounts on the frame 62 of the panel 60. In one embodiment, the pins 66 are configured to selectively engage apertures 68 in the rack 20, such as the supports 52. One or more of the pins 62 may preferably be moved in and out (towards and away from the panel 60).

When the pins 66 are moved outwardly and they are aligned with the apertures 68, they preferably extend into those apertures 68, thus connecting them to the rack 20. On the other hand, when one more of the pins 66 are moved inwardly, the panel 60 can preferably be removed from the rack 20.

As detailed below, apertures 68 or other mounts may be located at various points of the rack 20, thus permitting the panel 60 to be connected to the rack 20 in various orientations and/or locations.

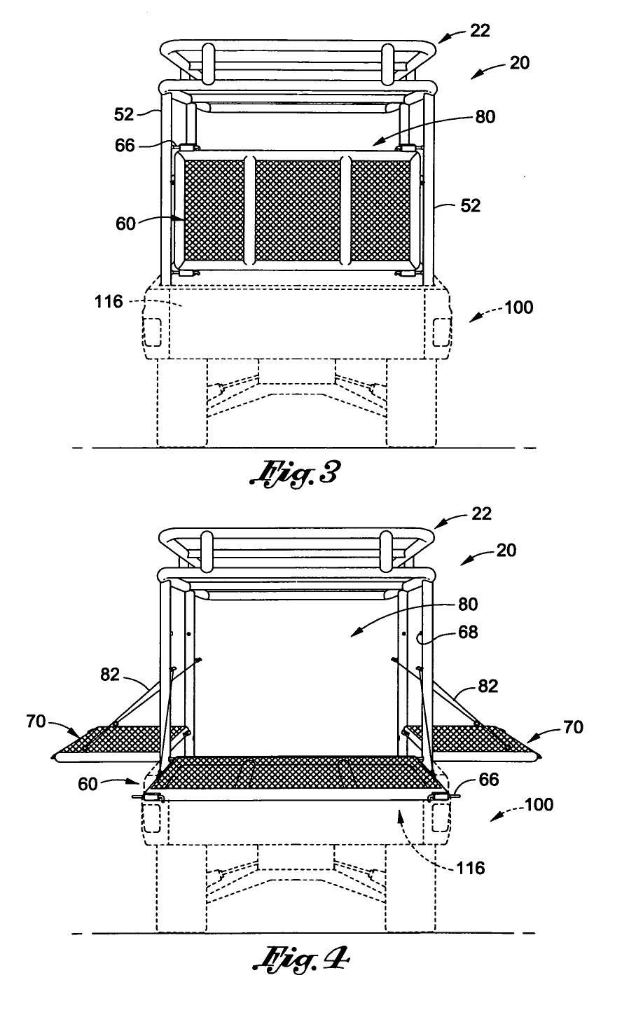

In one embodiment, the rack 20 also includes one or more side panels 70. Each side panel 70 may be similar to the rear panel 60, such as having a frame 72, such as which defines a periphery of the panel 70, and decking 74 or the like. In addition, the side panels 70 may also be configured to be selectively mounted to the rack 20 and/or be configured to be mounted to the rack 20 in different locations and/or orientations. In one embodiment, the side panels 70 are preferably mountable between front and rear pairs of the supports 52 of the rack 20, as illustrated in FIGS. 1 and 2. Once again, the side panels 70 may be mounted with one or more pins 66 which selectively engage one or more apertures 68.

Of course, the side panels 70 and rear panel 60 may be mounted to the rack in various manners. For example, instead of using mounting pins 66, the panels 60,70 might be mounted with hinges or other types of fasteners or mounts.

In one embodiment, the pins 66 may be spring loaded. For example, a spring may be located in each mount, the spring configured to bias the pin 66 to its extended position. This ensures that the pin 66 remains extended into a mating aperture 68, thus maintaining the panel 60,70 in the desired position. A user may pull the pin 66 inwardly against the spring to retract it out of engagement with an aperture and thus move the panel 60,70.

Various features of the invention, including aspects of use, will now be described with reference to the figures. As indicated above, the invention has particular utility to a UTV. FIG. 2 illustrates the rack 20 of the invention associated with one example of a UTV. As detailed herein, the invention has applicability to other vehicles, including UTV's having other configurations. In the illustrated example, the UTV 100 has a main area or cab 102. The cab 102 may be enclosed or, as illustrated, be generally open. One or more seats 104 and driver controls may be located in the cab area 102. In the configuration illustrated, user may be protected by a roll cage 106 which extends over the seats 104 and around the cab 102.

In one embodiment, the UTV 100 has a front 108, such as hood section which extends over one or more front wheels 110 and a motor or engine. The UTV 100 also has a rear 112 and one or more rear wheels 114. In one embodiment, at least a portion of the rear 112 of the UTV 100 is defined by a bed 116. As described below, the bed 116 may be movable between raised and lowered positions (where the bed 116 is illustrated in its lowered position in FIG. 2 and is illustrated in its raised or tilted position in FIG. 7).

As illustrated in FIG. 2, the rack 20 may be mounted to the UTV 100, and preferably to the bed 116 thereof. In one embodiment, one or more of the supports 52 of the rack 20 are mounted to the UTV 100. For example, the supports 52 may be bolted, welded, clamped or otherwise connected to the bed 116 of the UTV 100. As indicated above, the supports 52 may include feet to aid in such mounting, such as to removably receive one or more mounting bolts which fasten them to the bed 116. Of course, other means of connection may be provided. For example, one or more brackets or other mounts may be used to connect the supports 52 to the UTV 100. It is preferred, though not required, that each support 52 be connected to the UTV 100. The rack 20 may be mounted to a bottom of the bed 116, the sides or other portions thereof.

Of course, relative to a UTV 100 which does not include a bed 116, the rack 20 might be connected to other portions thereof. For example, the rack 20 might be connected to a frame of a vehicle.

As illustrated, once the rack 20 is mounted to the UTV 100, it preferably extends upwardly from the UTV 100. In a preferred embodiment, the raised storage area 22 extends towards the front of the UTV 100, such as over the cab section 201, including the roll cage 106.

In this regard, it will be appreciated that the size and shape of the rack 20 may vary, such as depending upon the particular application. For example, relative to the application illustrated in FIG. 2, it is preferred that the supports 52 be spaced apart a distance which permits them to fit within the bed 116 of the UTV 100. Of course, the distance which the supports 52 are spaced apart, their shape and/or orientation, might vary depending upon the size/shape of the bed 116 or other portion of an UTV 100 to which the rack 20 is to be mounted. For example, an UTV 100 might not include a bed 116 but may instead merely have a rear section. The one or more supports 52 may then be spaced or oriented to align with designated mounting points of the UTV 100.

Further, as illustrated, the rack 20 is preferably configured so that the raised storage area 22 extends over the cab 102. In the event that the cab 102 is enclosed or, as illustrated, includes a roll cage 106, the raised storage area 22 is preferably raised sufficiently high to clear or extend above that portion of the UTV 100.

In one embodiment, the height of the raised storage area 22 might be adjustable. For example, the supports 52 might be length adjustable. In one configuration, each support 52 might comprise a first leg section which mates with a second leg section, where the relative position of the two leg sections may be adjustable, such as by passing a pin through mating apertures, by screwing the two leg sections into or out of one another or the like. In this manner, the rack 20 might be adjusted for use with different vehicles (such as vehicles having different cab heights).

In addition, the total size of the rack 20 may vary. For example, as illustrated in FIG. 2, the raised storage area 22 may only extend over the cab 102. However, it could extend further forward, such as to a point over the front 108 of the UTV 100. In addition, the width of the rack 20 might vary, such as depending upon the width of the UTV 100.

It is also possible for the size of the raised storage area 22 to be adjustable. For example, a front portion of the raised storage area 22 might be capable of being slid in or out of a rear section. This or other configurations would permit the raised storage area 22 to be expanded (such as extended forwardly) or contracted (such as collapsed rearward) by some distance.

Of course, the configuration of the rack 20 may also vary depending upon the vehicle with which the rack 20 is to be associated. For example, the shape of the rack 20 might differ if it is to be associated with a vehicle other than a UTV.

Various additional features and advantages of the rack 20 will now be described with reference to FIGS. 2-7. First, as illustrated in these figures, the rack 20 defines a raised storage area 22. This storage area 22 preferably includes at least a front portion 38 which has a deck 46 for supporting cargo. In addition, the raised portion 36 of the frame 24 of the raised storage area 22 aids in maintaining cargo on the rack 20. For example, a user might store camping or hunting equipment by placing it on the deck 46 of the front portion 38 of the raised storage area 22. The user might further secure that equipment by use of ropes, elastic cord, a covering or the like, as desired.

Advantageously, the raised storage area 22 defines additional cargo storage/carrying capacity for the vehicle. Further, the raised storage area 22 does not interfere with the operation of the UTV 100 or other vehicle. In particular, because it is raised above the vehicle, it does not interfere with the cab 102, wheels 100,114, block the view of the driver or any passenger or the like. At the same time, the raised storage area 22 is convenient to access, such as by a user stepping on side steps or rails of the UTV and then reaching into the raised storage area 22.

Another benefit of the rack 20 in the preferred configuration as illustrated is that a rear portion 40 the raised storage area 22 is open. In this configuration, a user may locate very tall or long cargo items in the rack 20 so that they extend upwardly through the rear portion 40. Similarly, a user might stand with in the rack 20 with the top portion of their body, such as their head, extending out through the open rear portion 40 of the raised storage area 22.

Referring to FIGS. 2 and 3, the side and/or rear panels 60,70 may be used to generally close the lower portion 80 of the rack 20. For example, as illustrated in FIGS. 1 and 3, the rear panel 60 may be located in a raised, closed position in which it extends generally vertically between the rear supports 52. As illustrated in FIGS. 1 and 2, the side panels 70 may be located in a raised, closed position in which they extend generally vertically between the side supports 52. In this configuration, the rear and side panels 60,70 cooperate to generally enclose the lower portion of the rack 20.

Of course, the degree to which the lower portion 80 of the rack 20 is enclosed may depend in part upon the size of the panels 60,70. In one embodiment, the panels 60,70 might be sized to enclose the entirety of the space between the supports 52. In another embodiment, as illustrated, the panels 60,70 may be sized to close approximately the bottom ⅔ of the space.

With the panels 60,70 in this position, a user may locate cargo within the lower portion 80 of the rack 20 and have that cargo safely secured. For example, a user might locate hunting or camping equipment within the lower portion 80 of the rack 20. The panels 60,70 ensure that the equipment does not bounce or roll off of the UTV 100, such as when the user is turning or encountering bumps or the like when on a rough road.

As illustrated in FIG. 4, in one embodiment the panels 60,70 may be moved to a lowered, shelf position or configuration. For example, the top pins 66 corresponding to each panel 60,70 may be released, thus allowing the panels to be rotated about their lower pins 66. As illustrated, the top of each panel 60,70 may be rotated outwardly from the rack 20. While the panels 60,70 might be moved to various positions, in one preferred embodiment they may be moved to a generally horizontal position.

In one embodiment, means may be provided for selectively maintaining the panels 60,70 in the position illustrated in FIG. 4 (or other positions). Such a means might comprise a ratcheting system, straps, cables, hinge lock, stop, piston/hydraulic arm or the like. In one embodiment, the means comprises one or more cable stops 82. The cable stops 82 may comprise lengths of cable which extend between a panel and the rack 20, such as one of the supports 52. The length of each cable 82 is chosen so that it prevents movement of the panel beyond the horizontal position. Of course, multiple cables 82 may be associated with each panel 60,70, as illustrated, though as few as one cable may be utilized. In addition, as indicated, various other means may be utilized to serve this same position-stop function.

With the panels 60,70 in the position illustrated in FIG. 4, a user may access the lower interior area of the rack 20. This allows, for example, a user to reach cargo and the like which is stored within the rack 20 and the bed 116 of the UTV 100. In addition, the panels 60,70 serve as shelves or supports. A user may thus place objects on the panels 60,70 or otherwise use the panels 60,70 as a support or work surface.

It is also noted that in the illustrated embodiment, the rear and side panels 60,70 may be removed entirely to permit access to the interior area 80 and/or facilitate large cargo. For example, each panel 60.70 may be disconnected from the rack 20 by disengaging the pins 66 associated with each panel from the supports 52.

The rear panel 60 and/or side panels 70 may also be used as a seating surface. FIG. 5 illustrates the rear panel 60 in a position in which it may be used as a seat. As illustrated, the rear panel 60 may be lowered and rotated inwardly (as opposed to outwardly as illustrated in FIG. 4). The rear panel 60 may be, for example, fixed into a horizontal position in which it extends into the lower area 80 of the rack 20 (and thus extends into the bed 116 of the UTV 100 as illustrated). In one embodiment, a user may release the top pins 66 of the rear panel 60, thus permitting the rear panel 60 to be rotated about the lower pins 66. The user may rotate the rear panel 60 inwardly and then fix the top pins 66 to apertures 68 in the front supports 52, thus fixing the rear panel 60 into the position illustrated.

In this configuration, a user may use the rear panel 60 as a seating surface. For example, one or more users may climb into the bed 116 of the UTV 100 and sit upon the rear panel 60.

In one or more embodiment, either or both of the side panels 70 might also be rotated inwardly and thus used as a seat or additional seating surfaces. If desired, the rear panel 60 and side panels 70 might be rotated inwardly, thus forming a generally “U” shaped seat within the interior area 80 of the rack 20.

Referring to FIG. 6, the rear panel 60 might also be moved to a shelf position. In the embodiment illustrated, the rear panel 60 might be moved to a raised, horizontal position within the interior area 80 of the rack 20. For example, the pins 66 might be connected to four apertures in the four supports 52, those apertures being located vertically along the supports.

An additional advantage of the invention will now be described with reference to FIG. 7. One particular advantage of the invention is that the rack 20 provides all of the above-referenced storage, support and containment features described above without interfering with the operation of the UTV 100, including, in one embodiment, tilting of the bed 116. Various UTVs have a tilting bed. This allows the bed 116 bed to be moved from a lowered, generally horizontal position, as illustrated in FIG. 2, to a raised or tilted position as illustrated in FIG. 7.

In accordance with the invention, the rack 20 is configured to be mounted to and completely supported by the bed 116 of the UTV 100. Thus, when the bed 116 is moved, the rack 20 is configured to move with the bed 116 and is configured so that it does not interfere with movement of the bed 116. For example, because the raised storage area 22 is located above the cab 102 and there are otherwise no other portions of the rack 20 which extend into or connect to the UTV 100, when the bed 116 is tilted, the rack 20 does not hit or encounter any portions of the UTV 100 when the rack 20 moves with the bed 116.

This is a significant advantage. Various other mounts and racks may provide some storage benefits but then interfere with the tilt operation of the bed 116, thus negating one important base feature of the UTV 100, and thus also making such a rack less desirable.

In one embodiment, if it is desired, additional connectors may be provided for securing the rack 20 to the roll cage 106 or other portions of the UTV 100, which connectors also do not interfere with the tilting of the bed 116. For example, straps, cables or other elements may be selectively connected between the UTV 100 and the rack 20. Such straps may be used to further tighten the rack 20 to the UTV 100. Preferably, the straps or other connectors may be easily disconnected to permit tilting of the bed 116 as described above.

In one embodiment, when the UTV 100 includes a tilting bed 116, a safety chain, cable, rope or other connector may be connected between the UTV 100 and the rack 20 (such as the front supports 52). The length of the chain or other connector may be selected to permit the bed 116 to be tilted, but also serve as a safety stop to prevent over or hyper-rotation of the bed 116.

The various portions of the rack 20 may be constructed from various materials. For example, the frame 24 of the raised storage area 22 may be constructed from hollow tubular steel, aluminum or other durable and weather-resistant material. The rack 20 might be painted, plated or otherwise, such as depending upon the desired application.

Of course, the rack 20 may have various other features and configurations. For example, as indicated above, the rack 20 preferably comprises four supports 52. However, the rack 20 might comprise a greater or lesser number of supports, such as 3 or 6, as examples.

It will be appreciated that the shape of the rack 20, including the raised storage area 22, may vary.

In one embodiment, the rack 20 might include a rear panel 60 and another panel which may be used as an internal shelf (i.e., instead of moving the rear panel 60 to the position illustrated in FIG. 6, an additional panel might be provided). Also, it is possible for the rack 20 to include a front panel which is located between the front supports 52 (and thus generally behind the cab 102 of the UTV 100 as illustrated in FIG. 2). Such a front panel may be used to keep cargo from moving forwardly into the cab 102.

Further, the rack 20 may include other numbers of panels. As indicated, the rack 20 preferably includes at least one (1) panel and preferably three (3). The rack 20 might, for example, only include a rear panel or only include side panels. It is also possible for the rack 20 to have multiple side and/or rear panels. For example, the rack 20 might include upper and lower side panels. These panels might rotate in the same or opposite directions between open and closed positions.

In one embodiment, it is also possible for a rear portion of the frame 24 of the raised storage area 22 to be removable or movable to permit easier access into the lower area 80 of the rack 20 and the bed 116 of the UTV 100. For example, a rear portion of the frame 24 (including both the lower and raised portions thereof) may be hinged at one end so that the rear portion can be swung or rotated upwardly from its normally horizontal to a substantially vertical position. Alternatively, that portion could be entirely removable. Of course, various connectors such as latches, hinges and the like could be utilized to permit that portion of the frame 24 to be selectively connected and removed or selectively moved.

It is also possible for the rear and/or side panels 60,70 to rotate or move about a generally vertical axis rather than a horizontal axis (i.e. permit the panels 60,70 to swing like a door).

Of course, in one embodiment the rack 20 might be configured so that decking may be located in the rear portion 40 as well as the front portion 38, such as to add more raised storage capacity. In one embodiment, the decking associated with the front and/or rear portions 38,40 might be removable to as to change the configuration of that area.

In one embodiment, it is also possible for the decking 46 of the raised storage area 22 to comprise other than expanded metal. For example, the decking 46 might comprise a solid material so that the rack 20 serves as a sun-shield or shade. Likewise, the panels 60,70 may be constructed with solid interior material so as to more completely close or shade the interior area 80 of the rack 20.

In one embodiment, the rack 20 might include various additional features or options. For example, the rack 20 might include hooks or tie-down points, lights or light mounts. The rack 20 might also include other storage elements such as elongate cylinders (such as attached to the raised storage area 22 and extending horizontally or attached to a support 52 and extending vertically) for fishing rods or the like.

In one embodiment, the rack 20 might include drawers or other closeable storage compartments. For example, one or more drawers might be located between two or more of the supports 52 or be located in the bed 116. One or more of the drawers might be lockable.

One or more cross-bars or other mounts may be connected to one or both of the front supports 52, such as to provide convenient mounting or storage of elements within reach of the cab 102 of the UTV 100. For example, the mounts might support speakers, fishing rods, firearms or the like.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A vehicle rack comprising:
a raised storage area, said raised storage area comprising a lower frame portion and a raised frame portion, said raised storage area defining a front portion and a rear portion, further comprising decking located at said front portion, said decking comprising a supporting surface of said raised storage area;
at least two supports, said at least two supports extending downwardly from said raised storage area and configured to support said raised storage area in a raised position, said rack having a lower area beneath said raised storage area and within said supports; and
at least one panel connected to at least two of said supports, said at least one panel configured to be movable between a first raised position in which said at least one panel is generally vertically extending and serves to enclose said interior lower and a second lowered position in which said at least one panel is generally horizontally extending and provides user access to said lower area.

2. The vehicle rack in accordance with claim 1 wherein said vehicle rack comprises four supports.

3. The vehicle rack in accordance with claim 1 wherein said lower frame portion generally defines a periphery of said raised storage area.

4. The vehicle rack in accordance with claim 3 wherein said raised frame portion is located 2-8 inches above said lower frame portion.

5. The vehicle rack in accordance with claim 1 wherein said rear portion of said raised storage area is open.

6. The vehicle rack in accordance with claim 1 wherein said at least two supports are located towards a rear of said raised storage area.

7. In combination, a vehicle rack and a vehicle having a cab and a bed located rearward of said cab:
at least two supports, each support having a proximal end and a distal end, said distal end of each support connected to said bed of said vehicle, said at least two support extending generally vertically upward from said bed of said vehicle;
a raised storage area supported by said at least two supports in a position raised above said bed of said vehicle, said raised storage area comprising a lower frame portion and a raised frame portion, said raised storage area defining a front portion and a rear portion, further comprising decking located at said front portion, said decking comprising a supporting surface of said raised storage area; and
at least one panel connected to at least two of said supports, said at least one panel configured to be movable between a first raised position in which said at least one panel is generally vertically extending and serves to enclose said interior lower and a second lowered position in which said at least one panel is generally horizontally extending and provides user access to said lower area.

8. The combination in accordance with claim 7 wherein said rack comprises four supports.

9. The combination in accordance with claim 7 wherein at least a portion of said front portion of said raised storage area extends forwardly over said cab of said vehicle.

10. The combination in accordance with claim 7 wherein said rack comprises four supports defining a rear of said rack and first and second sides, and wherein a first panel is located at said rear of said rack between first and second of said supports, a second panel is located at said first side between first and third of said supports, and a third panel is located at said second side between second and fourth of said supports.

11. The combination in accordance with claim 10 wherein said rear panel is selectively disconnectable from said rack.

12. The combination in accordance with claim 11 wherein said rear panel is selectively movable to a generally horizontal raised shelf position in said lower area of said rack.

13. The combination in accordance with claim 11 wherein said rear panel is configured to be rotated into said lower area of said rack into a generally horizontal seating position.

14. The combination in accordance with claim 7 wherein said rear portion of said raised storage area is generally open and located above said lower area.

15. The combination in accordance with claim 7 wherein said at least one panel is mounted to said supports with pins.
